(19) United States
(12) Patent Application Publication
(10) Pub. No.: US 2014/0348164 A1
(43) Pub. Date: Nov. 27, 2014

(54) MAINTAINING A MULTICAST FORWARDING TABLE AND A PIM ROUTER

(71) Applicant: Hangzhou H3C Technologies Co., Ltd., Hangzhou City, Zhejiang (CN)

(72) Inventors: Di Zhou, Haidian District (CN); Yu Liu, Haidian District (CN); Xusheng Chen, Haidian District (CN)

(73) Assignee: Hangzhou H3C Technologies Co., LTD., Hangzhou City, Zhejiang (CN)

(21) Appl. No.: 14/358,782

(22) PCT Filed: Jan. 16, 2013
(86) PCT No.: PCT/CN2013/070510

§ 371 Date: May 16, 2014

(30) Foreign Application Priority Data
Jan. 18, 2012 (CN) 201210014059.7

(51) Int. Cl. H04L 12/18; H04N 21/6405

(52) U.S. Cl. CPC H04L 12/185; H04N 21/6405
USPC 370/390

(57) ABSTRACT

A method for maintaining a multicast forwarding table item and a Protocol Independent Multicast (PIM) router are disclosed. The method includes: receiving, by a PIM router, a multicast leave message for leaving a multicast group through an input port, finding, by the PIM router, a multicast forwarding table item corresponding to the multicast group in the PIM router, deleting the input port through which the multicast leave message is received from an output port list of the multicast forwarding table item, if there is a switcher identifier on the input port in the output port list and the output port list of the multicast forwarding table item is empty, deleting the multicast forwarding table item immediately or accelerating the deletion of the multicast forwarding table item, wherein the switcher identifier indicates that the input port corresponds to a switcher.

### BACKGROUND

Internet Protocol (IP) video surveillance has become a mainstream technology of the security field. For a live broadcast of surveillance videos, a plurality of users may require watching videos of one camera. In this case, IP multicast may be a good choice.

In conventional IP multicast, if two surveillance hosts and a surveillance TV wall watch videos of the same camera at the same time, the camera only needs to output one copy of a multicast stream. As such, the load of the camera is reduced compared with live broadcast based on unicast. The camera does not need to replicate the multicast stream. Network devices will replicate the multicast stream at proper nodes according to requirements of recipients. Thus, traffic load of the network is also reduced.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network structure according to an example of the present disclosure.

FIG. 2 is a flowchart illustrating a method for maintaining a multicast forwarding table when a switcher joins in the multicast group according to an example of the present disclosure.

FIG. 3 is a flowchart illustrating a method for maintaining a multicast forwarding table when a non-switcher joins in the multicast group according to an example of the present disclosure.

FIG. 4 is a flowchart illustrating a method for maintaining a multicast forwarding table when a multicast recipient leaves the multicast group according to an example of the present disclosure.

FIG. 5 is a schematic diagram illustrating a structure of a PIM router according to an example of the present disclosure.

FIG. 6 is a schematic diagram illustrating another structure of a PIM router according to an example of the present disclosure.

### DETAILED DESCRIPTION

Hereinafter, the present disclosure will be described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Conventional IP multicast technique may reduce the load of the camera and traffic load of the network. But there is a problem associated with forwarding table capacity in surveillance services, especially in scenarios where a switcher exists. A “switcher” is a device that switches among different multicast groups/streams, for example but not limited to a TV or surveillance device which is capable of receiving different video streams. The switcher may switch the multicast groups that it joins in periodically, i.e., the switcher may join a set of multicast group(s) at first, and then leaves the set to join another set of multicast group(s). When a time period ends, the switcher leaves the set of multicast group(s) that the switcher joins during the time period, and joins another set of multicast group(s). For example, if the switcher is a surveillance TV wall, the surveillance TV wall usually switches the multicast groups it joins every five seconds. In other words, the surveillance TV wall joins dozens of multicast groups to receive multicast streams, leaves these multicast groups and then joins another set of multicast groups every five seconds. When the switcher leaves the set of multicast groups, a Protocol Independent Multicast (PIM) router does not forward the multicast streams of these multicast groups to the switcher anymore. However, (multicast source S, multicast group G) or (S, G) items of these multicast groups will not be deleted from the PIM router at once. Instead, the (S, G) items will be reserved for another three minutes (aging time), so as to avoid over-consuming the resources of the PIM router due to frequent joining and leaving.

The large amount of useless (S, G) items occupy limited forwarding item capacity of the PIM router. Forwarding resources of the PIM router may be exhausted when the amount of the useless items reaches a certain number. Consequently, the router will be unable to receive new multicast streams.

In contrast, an example of the present disclosure provides a method for maintaining a multicast forwarding table item. The method includes:

receiving, by a PIM router, a multicast leave message for leaving a multicast group through an input port,

finding, by the PIM router, a multicast forwarding table item corresponding to the multicast group,

deleting, by the PIM router, the input port from an output port list of the multicast forwarding table item,

if there is a switcher identifier on the input port in the output port list and the output port list of the multicast forwarding table item is empty, deleting the multicast forwarding table item immediately or accelerating the deletion of the multicast forwarding table item, wherein the switcher identifier indicates that the input port corresponds to a switcher.

In examples of the present disclosure, the acceleration of the deletion of the multicast forwarding table item means that the multicast forwarding table item will be deleted before an aging time of the multicast forwarding table item elapses.

Hereinafter, the present disclosure is described in further detail with reference to accompanying drawings and examples.

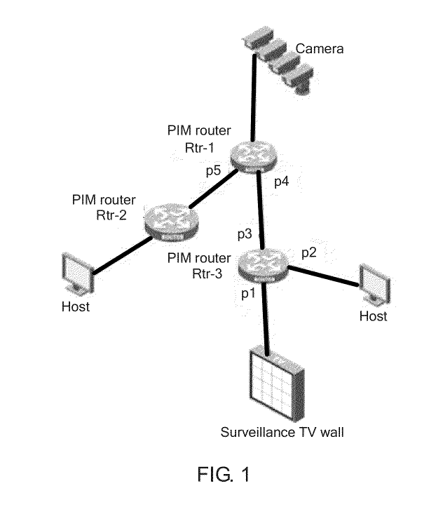

The examples of the present disclosure mainly include: a maintaining procedure of the multicast forwarding table item when a switcher joins a multicast group; a maintaining procedure of the multicast forwarding table item when a non-switcher joins the multicast group; and a maintaining procedure of the multicast forwarding table item when a multicast recipient leaves the multicast group. Hereinafter, the above three procedures will be described respectively with reference to the example network structure as shown in FIG. 1.

FIG. 1 is a schematic diagram illustrating a network structure according to an example of the present disclosure. As shown in FIG. 1, Rtr-1, Rtr-2 and Rtr-3 are PIM routers, and p1 to p5 denote interfaces of the PIM router.

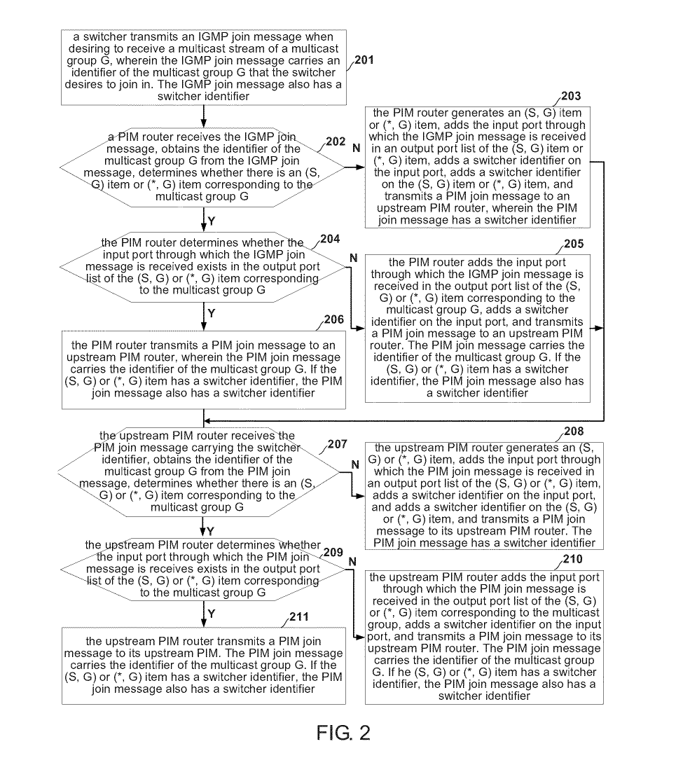

FIG. 2 is a flowchart illustrating a method for maintaining a multicast forwarding table item when a switcher joins a multicast group according to an example of the present disclosure. As shown in FIG. 2, the method includes the following.

At block 201 in FIG. 2, a switcher transmits an Internet Group Management Protocol (IGMP) join message to receive a multicast stream of a multicast group G, wherein the IGMP join message carries an identifier of the multicast group G that the switcher desires to join. The IGMP join message also has a switcher identifier. The switcher identifier indicates that the IGMP join message is transmitted by a switcher.

As shown in FIG. 1, suppose that the surveillance TV wall has 4*4 sub-screens. The surveillance TV wall will transmit 16 IGMP join messages for joining 16 multicast groups at one time, wherein each of the 16 IGMP join messages has a switcher identifier.

At block 202 in FIG. 2, a PIM router receives the IGMP join message through an input port, obtains the identifier of the multicast group G from the IGMP join message, determines whether there is an (S, G) item or (*, G) item corresponding to the multicast group G in the PIM router. S denotes multicast source, G denotes the identifier of the multicast group. If there is an (S, G) item or (*, G) item in the PIM router, block 204 is performed; otherwise, block 203 is performed.

At block 203 in FIG. 2, the PIM router generates an (S, G) item or (*, G) item corresponding to the multicast group, adds the input port through which the IGMP join message is received in an output port list of the (S, G) item or (*, G) item, adds a switcher identifier on the input port in the output port list and adds a switcher identifier on the (S, G) item or (*, G) item, and transmits a PIM join message to an upstream PIM router. The PIM join message carries the identifier of the multicast group G and a switcher identifier. Then, block 207 is performed.

For example, suppose that Rtr-3 as shown in FIG. 1 receives 16 IGMP join messages carrying switcher identifiers from the surveillance TV wall through interface p1. For each of the 16 IGMP join messages, if Rtr-3 finds that there is no corresponding (S, G) or (*, G) item, Rtr-3 generates an (S, G) or (*, G) item, adds interface p1 to the output port list of the (S, G) or (*, G) item, adds a switcher identifier on interface p1, adds a switcher identifier on the (S, G) or (*, G) item, and transmits a PIM join message carrying a switcher identifier to an upstream PIM router.

At block 204 in FIG. 2, the PIM router determines whether the input port through which the IGMP join message is received exists in the output port list in the (S, G) or (*, G) item corresponding to the multicast group G. If the input port exists in the output port list, block 206 is performed; otherwise, block 205 is performed.

At block 205 in FIG. 2 (input port not on the list), the PIM router adds the input port through which the IGMP join message is received in the output port list of the (S, G) or (*, G) item corresponding to the multicast group G, adds a switcher identifier on the input port in the output port list, and transmits a PIM join message to the upstream PIM router. The PIM join message carries the identifier of the multicast group G. If the (S, G) or (*, G) item has a switcher identifier, the PIM join message also has a switcher identifier. Then, block 207 is performed.

In block 205, if the (S, G) or (*, G) item does not have a switcher identifier, it indicates that there is a non-switcher under the PIM router. In this case, the PIM join message transmitted by the PIM router does not have a switcher identifier.

For example, suppose that Rtr-3 as shown in FIG. 1 receives 16 IGMP join messages carrying switcher identifiers from the surveillance TV wall. For each of the 16 IGMP join messages, if Rtr-3 finds that there is a corresponding (S, G) or (*, G) item, if interface p1 already exists in the output port list of the (S, G) or (*, G) item, interface p1 is not required to be added again. Otherwise, Rtr-3 adds interface p1 in the output port list of the (S, G) or (*, G) item, and adds a switcher identifier on interface p1. If interface p1 already exists in the output port list of the (S, G) or (*, G) item, if interface p1 already has a switcher identifier, it is not required to add the switcher identifier again; if interface p1 does not have the switcher identifier, it indicates there is a non-switcher under interface p1. Thus, no switcher identifier should be added.

At block 206 in FIG. 2, the PIM router transmits a PIM join message to the upstream PIM router, wherein the PIM join message carries the identifier of the multicast group G. If the (S, G) or (*, G) item has a switcher identifier, the PIM join message also has a switcher identifier.

Similarly, in block 206, if the (S, G) or (*, G) item does not have a switcher identifier, it indicates that there is a non-switcher under the PIM router. Thus, the PIM join message transmitted to the upstream PIM router should not have the switcher identifier.

At block 207 in FIG. 2, the upstream PIM router receives the PIM join message carrying the switcher identifier, obtains the identifier of the multicast group G from the PIM join message, determines whether there is an (S, G) or (*, G) item corresponding to the multicast group G in the upstream PIM router. If there is, block 209 is performed; otherwise, block 208 is performed.

At block 208 in FIG. 2, the upstream PIM router generates an (S, G) or (*, G) item corresponding to the multicast group G, adds the input port through which the PIM join message is received in an output port list of the (S, G) or (*, G) item, adds a switcher identifier on the input port, and adds a switcher identifier on the (S, G) or (*, G) item, and transmits a PIM join message to its upstream PIM router. The PIM join message carries the identifier of the multicast group G and has a switcher identifier.

For example, suppose that Rtr-1 receives 16 PIM join messages carrying switcher identifiers from Rtr-3 through interface p4. For each PIM join message, if Rtr-1 finds that there is no (S, G) or (*, G) item, Rtr-1 generates a corresponding (S, G) or (*, G) item, adds interface p4 in the output port list of the (S, G) or (*, G) item, adds a switcher identifier on interface p4, adds a switcher identifier on the (S, G) or (*, G) item, and transmits a PIM join message carrying a switcher identifier to an upstream PIM router of Rtr-1.

At block 209 in FIG. 2, the upstream PIM router determines whether the input port through which the PIM join message is received exists in the output port list of the (S, G) or (*, G) item corresponding to the multicast group G. If the input port exists in the output port list, block 211 is performed; otherwise, block 210 is performed.

Block 210, the upstream PIM router adds the input port through which the PIM join message is received in the output port list of the (S, G) or (*, G) item corresponding to the multicast group G, adds a switcher identifier on the input port, and transmits a PIM join message to its upstream PIM router. The PIM join message carries the identifier of the multicast group G. If the (S, G) or (*, G) item has a switcher identifier, the PIM join message also has a switcher identifier.

For example, suppose that Rtr-1 receives 16 PIM join messages carrying switcher identifier from Rtr-3 through interface p4. For each PIM join message, if Rtr-1 finds that there is a corresponding (S, G) or (*, G) item and interface p4 already exists in the output port list of the (S, G) or (*, G) item, it is not required to add interface p4 again. Otherwise, interface p4 is added in the output port list of the (S, G) or (*, G) item and a switcher identifier is added on interface p4. If interface p4 already exists in the output port list of the (S, G) or (*, G) item and has a switcher identifier, it is no required to add the switcher identifier again. Otherwise, if there is no switcher identifier on interface p4, it indicates that there is a non-switcher under interface p4. Thus, no switcher identifier should be added.

At block 211 in FIG. 2, the upstream PIM router transmits a PIM join message to its upstream PIM router. The PIM join message carries the identifier of the multicast group G. If the (S, G) or (*, G) item has a switcher identifier, the PIM join message also has a switcher identifier.

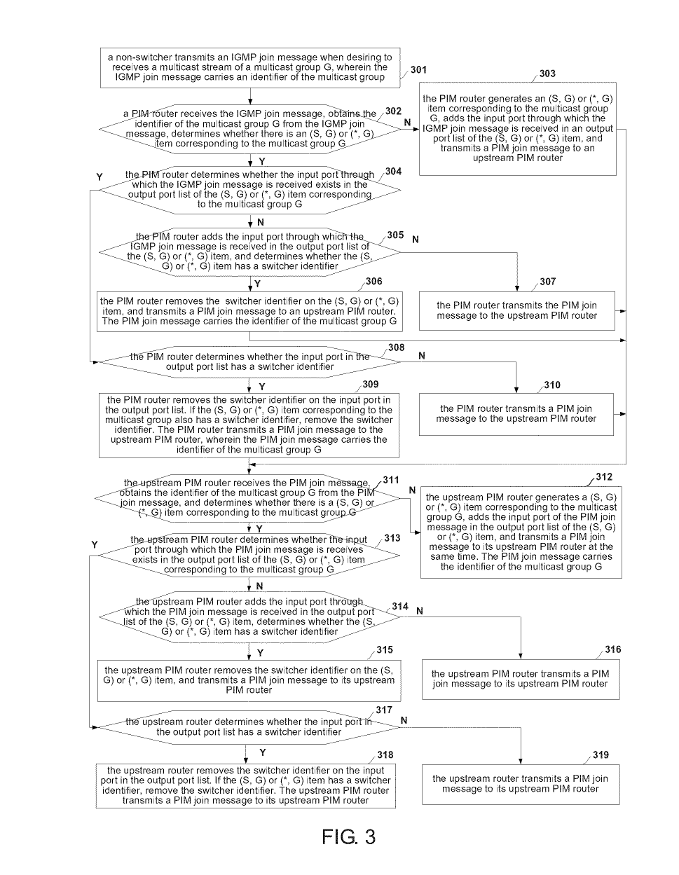

FIG. 3 is a flowchart illustrating a method for maintaining a multicast forwarding table item when a non-switcher joins in a multicast group. As shown in FIG. 3, the method includes the following.

At block 301 in FIG. 3, a non-switcher transmits an IGMP join message to receive a multicast stream of a multicast group G, wherein the IGMP join message carries an identifier of the multicast group that the non-switcher desires to join.

In block 301, the IGMP join message does not have a switcher identifier.

At block 302 in FIG. 3, a PIM router receives the IGMP join message through an input port, obtains the identifier of the multicast group G from the IGMP join message, determines whether there is an (S, G) or (*, G) item corresponding to the multicast group G in the PIM router. If there is an (S, G) or (*, G) item corresponding to the multicast group G, block 304 is performed; otherwise, block 303 is performed.

At block 303 in FIG. 3, the PIM router generates an (S, G) or (*, G) item corresponding to the multicast group G, adds the input port through which the IGMP join message is received in an output port list of the (S, G) or (*, G) item, and transmits a PIM join message to an upstream PIM router, wherein the PIM join message carries the identifier of the multicast group G. Then, block 311 is performed.

At block 304 in FIG. 3, the PIM router determines whether the input port through which the IGMP join message is received exists in the output port list of the (S, G) or (*, G) item corresponding to the multicast group G. If the input port exists in the output port list, block 308 is performed; otherwise, block 305 is performed.

At block 305 in FIG. 3, the PIM router adds the input port through which the IGMP join message is received in the output port list of the (S, G) or (*, G) item corresponding to the multicast group G, and determines whether the (S, G) or (*, G) item corresponding to the multicast group has a switcher identifier. If the (S, G) or (*, G) item has a switcher identifier, block 306 is performed; otherwise, block 307 is performed.

At block 306 in FIG. 3, the PIM router removes the switcher identifier on the (S, G) or (*, G) item, and transmits a PIM join message to an upstream PIM router. The PIM join message carries the identifier of the multicast group G. Then, block 311 is performed.

At block 307 in FIG. 3, the PIM router transmits a PIM join message to an upstream PIM router, wherein the PIM join message carries the identifier of the multicast group G. Then, block 311 is performed.

At block 308 in FIG. 3, the PIM router determines whether the input port of the IGMP join message in the output port list has a switcher identifier. If the input port has a switcher identifier, block 309 is performed; otherwise, block 310 is performed.

At block 309 in FIG. 3, the PIM router removes the switcher identifier on the input port in the output port list. In addition, if the (S, G) or (*, G) item corresponding to the multicast group G also has a switcher identifier, the switcher identifier also needs to be removed. The PIM router transmits a PIM join message to an upstream PIM router, wherein the PIM join message carries the identifier of the multicast group G. Then, block 311 is performed.

At block 310 in FIG. 3, the PIM router transmits a PIM join message to an upstream PIM router, wherein the PIM join message carries the identifier of the multicast group G.

At block 311 in FIG. 3, the upstream PIM router receives the PIM join message, obtains the identifier of the multicast group G from the PIM join message, and determines whether there is an (S, G) or (*, G) item corresponding to the multicast group G in the upstream PIM router. If there is an (S, G) or (*, G) item corresponding to the multicast group G, block 313 is performed; otherwise, block 312 is performed.

At block 312 in FIG. 3, the upstream PIM router generates an (S, G) or (*, G) item corresponding to the multicast group G, adds the input port of the PIM join message in the output port list of the (S, G) or (*, G) item, and transmits a PIM join message to its upstream PIM router. The PIM join message carries the identifier of the multicast group G.

At block 313 in FIG. 3, the upstream PIM router determines whether the input port through which the PIM join message is receives exists in the output port list of the (S, G) or (*, G) item corresponding to the multicast group G. If the input port exists in the output port list, block 317 is performed; otherwise, block 314 is performed.

At block 314 in FIG. 3, the upstream PIM router adds the input port through which the PIM join message is received in the output port list of the (S, G) or (*, G) item corresponding to the multicast group G, determines whether the (S, G) or (*, G) item corresponding to the multicast group G has a switcher identifier. If the (S, G) or (*, G) item has a switcher identifier, block 315 is performed; otherwise, block 316 is performed.

At block 315 in FIG. 3, the upstream PIM router removes the switcher identifier of the (S, G) or (*, G) item, and transmits a PIM join message to its upstream PIM router, wherein the PIM join message carries the identifier of the multicast group G.

At block 316 in FIG. 3, the upstream PIM router transmits a PIM join message to its upstream PIM router, wherein the PIM join message carries the identifier of the multicast group G.

At block 317 in FIG. 3, the upstream PIM router determines whether the input port in the output port list has a switcher identifier. If the input port has a switcher identifier, block 318 is performed; otherwise, block 319 is performed.

At block 318, the upstream router removes the switcher identifier on the input port in the output port list. In addition, if the (S, G) or (*, G) item corresponding to the multicast group G also has a switcher identifier, the switcher identifier should also be removed. The upstream PIM router transmits a PIM join message to its upstream PIM router, wherein the PIM join message carries the identifier of the multicast group G.

Block 319, the upstream router transmits a PIM join message to its upstream PIM router, wherein the PIM join message carries the identifier of the multicast group G.

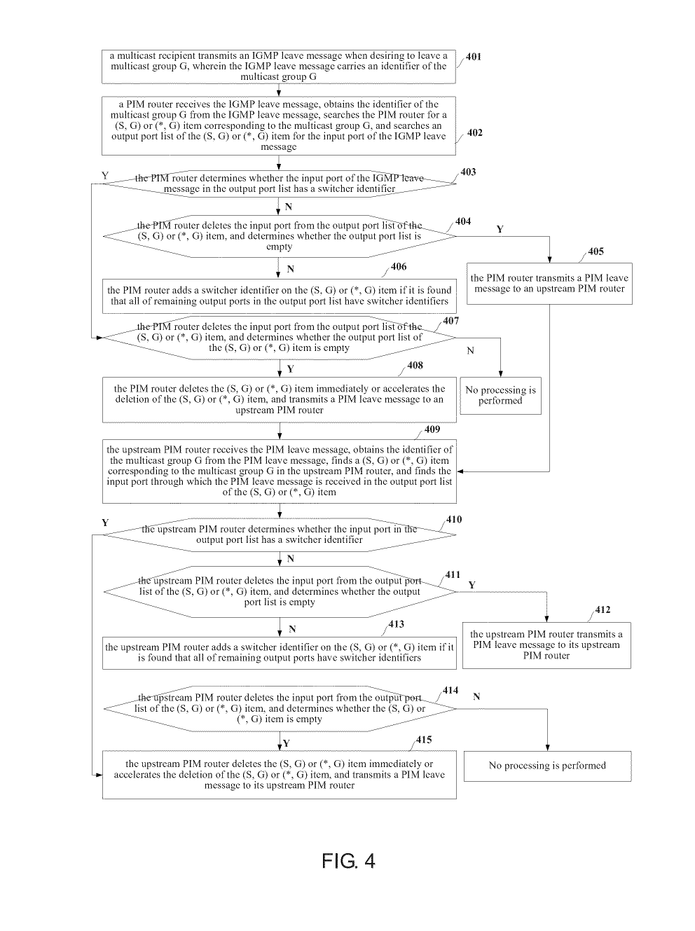

FIG. 4 is a flowchart illustrating a method for maintaining a multicast forwarding table item when a multicast recipient leaves a multicast group according to an example of the present disclosure. As shown in FIG. 4, the method includes the following.

At block 401 in FIG. 4, a multicast recipient transmits an IGMP leave message when desiring to leave a multicast group G, wherein the IGMP leave message carries an identifier of the multicast group G.

At block 402 in FIG. 4, a PIM router receives the IGMP leave message through an input port, obtains the identifier of the multicast group G from the IGMP leave message, searches for an (S, G) or (*, G) item corresponding to the multicast group G, and searches an output port list of the (S, G) or (*, G) item for the input port through which the IGMP leave message is received.

At block 403 in FIG. 4, the PIM router determines whether the input port in the output port list has a switcher identifier. If the input port has a switcher identifier, block 407 is performed; otherwise, block 404 is performed.

At block 404 in FIG. 4, the PIM router deletes the input port through which the IGMP leave message is received from the output port list of the (S, G) or (*, G) item, and determines whether the output port list is empty. If the output port list is empty, block 405 is performed; otherwise, block 406 is performed.

At block 405 in FIG. 4, the PIM router transmits a PIM leave message to an upstream PIM router, wherein the PIM leave message carries the identifier of the multicast group G. Then, block 409 is performed.

In this block, the PIM router deletes the (S, G) or (*, G) item once an aging time of the multicast forwarding table item elapses.

At block 406 in FIG. 4, the PIM router adds a switcher identifier on the (S, G) or (*, G) item if it is found that all of remaining output ports in the output port list have switcher identifiers.

In this block, if the PIM router finds that not all of the remaining output ports in the output port list have switcher identifiers, no processing is performed.

At block 407 in FIG. 4, the PIM router deletes the input port through which the IGMP leave message is received from the output port list of the (S, G) or (*, G) item, and determines whether the output port list of the (S, G) or (*, G) item is empty. If the output port list is empty, block 408 is performed; otherwise, no processing is performed.

At block 408 in FIG. 4, the PIM router deletes the (S, G) or (*, G) item immediately or accelerates the deletion of the (S, G) or (*, G) item, and transmits a PIM leave message to an upstream PIM router, wherein the PIM router carriers the identifier of the multicast group G. In this block, the acceleration of the deletion of the (S, G) or (*, G) item means that the (S, G) or (*, G) item will be deleted before the aging time of the (S, G) or (*, G) item elapses.

At block 409 in FIG. 4, the upstream PIM router receives the PIM leave message through an input port, obtains the identifier of the multicast group G from the PIM leave message, finds an (S, G) or (*, G) item corresponding to the multicast group G in the upstream PIM router, and finds the input port through which the PIM leave message is received in the output port list of the (S, G) or (*, G) item.

At block 410 in FIG. 4, the upstream PIM router determines whether the input port through which the PIM leave message is received in the output port list has a switcher identifier. If the input port has a switcher identifier, block 414 is performed; otherwise, block 411 is performed.

At block 411 in FIG. 4 (input port does not have a switcher identifier), the upstream PIM router deletes the input port through which the PIM leave message is received from the output port list of the (S, G) or (*, G) item, and determines whether the output port list is empty. If the output port list is empty, block 412 is performed; otherwise, block 413 is performed.

At block 412 in FIG. 4, the upstream PIM router transmits a PIM leave message to its upstream PIM router, wherein the PIM leave message carries the identifier of the multicast group G.

In this block, the upstream PIM router deletes the (S, G) or (*, G) item once the aging time elapses.

At block 413 in FIG. 4, the upstream PIM router adds a switcher identifier on the (S, G) or (*, G) item if it is found that all of the remaining output ports in the output port list have switcher identifiers.

In this block, if the upstream PIM router finds that not all of the remaining output ports in the output port list have switcher identifiers, no processing is performed.

At block 414 in FIG. 4 (input port has a switcher identifier), the upstream PIM router deletes the input port through which the PIM leave message is received from the output port list of the (S, G) or (*, G) item, and determines whether the (S, G) or (*, G) item is empty. If the output port list is empty, block 415 is performed; otherwise, no processing is performed.

At block 415 in FIG. 4, the upstream PIM router deletes the (S, G) or (*, G) item immediately or accelerates the deletion of the (S, G) or (*, G) item, and transmits a PIM leave message to its upstream PIM router, wherein the PIM leave message carries the identifier of the multicast group G.

The examples as shown in FIG. 2 to FIG. 4 are applicable to IPv4 multicast networks. As to IPv6 multicast networks, Multicast Listener Discovery (MLD) may be used instead of IGMP in the examples in FIG. 2 to FIG. 4.

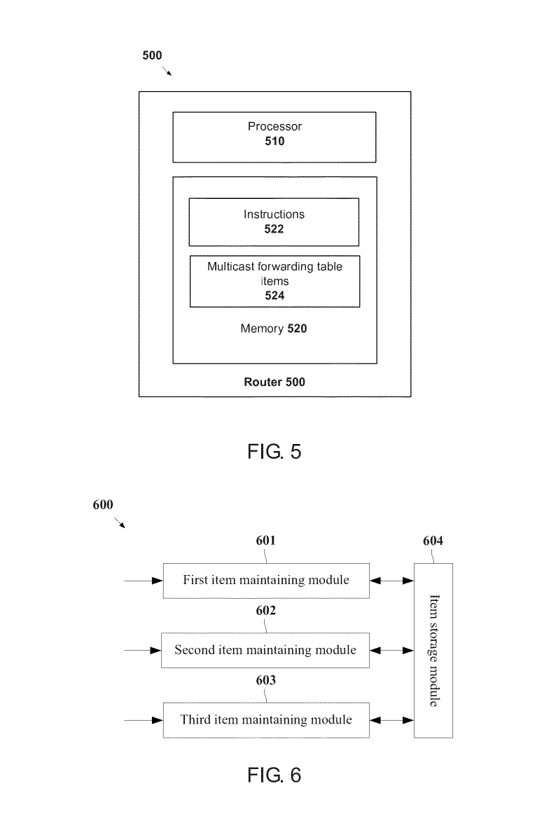

FIG. 5 is a schematic diagram illustrating a structure of a PIM router according to an example of the present disclosure. As shown in FIG. 5, the PIM router 500 includes a processor 510 coupled to a memory 520 with machine readable instructions 522 and multicast forwarding table items 524. The processor 510 is to execute the machine readable instructions 522 to implement a first item maintaining module to perform the following operations.

The processor 510 is to perform the operations described with reference with FIG. 1 to FIG. 4. In one example, the processor 510 is to:
receive a multicast leave message for leaving a first multicast group,
search the memory 520 for a first multicast forwarding table item corresponding to the first multicast group,
delete a first input port through which the multicast leave message is received from an output port list of the first multicast forwarding table item,
if the first input port in the output port list has a switcher identifier and the output port list of the first multicast forwarding table item is empty, delete the first multicast forwarding table item immediately or accelerate the deletion of the first multicast forwarding table item;
wherein the switcher identifier indicates that the input port corresponds to a switcher.

The acceleration of the deletion of the first multicast forwarding table item means that the first multicast forwarding table item will be deleted before an aging time of the first multicast forwarding table item elapses.

The processor 510 is further to:
after deleting the first input port through which the multicast leave message is received from the output port list of the first multicast forwarding table item, if the first input port in the output port list does not have a switcher identifier and the output port list is not empty, determine whether one or more remaining output ports in the output port list have switcher identifiers, and if yes add a switcher identifier on the first multicast forwarding table item.

The above describes the operations of the PIM router when a multicast recipient leaves a multicast group. According to an example of the present disclosure, the processor 510 may further execute machine readable instructions to implement a second item maintaining module when a switcher joins the multicast group and to implement a third item maintaining module when a non-switcher joins the multicast group.

FIG. 6 is a schematic diagram illustrating a structure of a PIM router according to an example of the present disclosure. As shown in FIG. 6, the PIM router 600 mainly includes: a first item maintaining module 601, a second item maintaining module 602, a third item maintaining module 603 and an item storage module 604. Functions and operations of the first item maintaining module 601 in FIG. 6 are the same as those described with reference to FIG. 5 and will not be repeated herein. It should be understood that the terms “first”, “second” and “third” are used throughout the specification for easy reference, and do not indicate any specific order. In practice, the first item maintaining module 601, second item maintaining module 602, and third item maintaining module 603 may be different modules or their function(s) combined into the same module.

The second item maintaining module 602 is to
receive through a second input port a first multicast join message for joining in a second multicast group, wherein the first multicast join message carries a switcher identifier,
determine whether there is a second multicast forwarding table item corresponding to the second multicast group in the item storage module 604,
if there is the second multicast forwarding table item corresponding to the second multicast group in the item storage module 604, add the second input port through which the first multicast join message is received in an output port list of the second multicast forwarding table item, and add a switcher identifier on the second input port in the output port list;
if there is no second multicast forwarding table item corresponding to the second multicast group in the item storage module 604, generate the second multicast forwarding table item corresponding to the second multicast group in the item storage module 604, add the second input port through which the multicast join message is received in an output port list of the second multicast forwarding table item, and add a switcher identifier on the second input port in the output port list;

The second item maintaining module 602 is further to:
if there is no second multicast forwarding table item corresponding to the second multicast group, add a switcher identifier on the newly generated second multicast forwarding table item while adding the switcher identifier on the second input port in the output port list, and transmit a PIM join message with a switcher identifier to an upstream PIM router.

The second item maintaining module 602 is further to:
if there is the second multicast forwarding table item corresponding to the second multicast group, before adding the second input port through which the first multicast join message is received in the output port list of the second multicast forwarding table item and adding the switcher identifier on the second input port in the output port list, determine whether the second input port exists in the second multicast forwarding table item,
if the first input port exists in the second multicast forwarding table item, determine whether the second multicast forwarding table item has a switcher identifier, if the second multicast forwarding table item has a switcher identifier, transmit a multicast join message with a switcher identifier to an upstream PIM router; if the second multicast forwarding table item has no switcher identifier, transmit a multicast join message with no switcher identifier to an upstream PIM router;
otherwise, if the second input port does not exist in the second multicast forwarding table item, perform the operations including adding the second input port through which the second multicast join message is received in the output port list of the second multicast forwarding table item and adding the switcher identifier on the second input port in the output port list, and
when adding the second input port through which the first multicast join message is received in the output port list of the second multicast forwarding table item and adding the switcher identifier on the second input port in the output port list, determine whether the second multicast forwarding table item has a switcher identifier,
if the second multicast forwarding table item has a switcher identifier, transmit a PIM join message with a switcher identifier to an upstream PIM router; otherwise, transmit a PIM join message without a switcher identifier to an upstream PIM router.

The third item maintaining module 603 is to:
receive a second multicast join message for joining in a third multicast group, wherein the second multicast join message does not have a switcher identifier;
determine whether there is a third multicast forwarding table item corresponding to the third multicast group in the item storage module 604;
if there is the third multicast forwarding table item corresponding to the third multicast group in the item storage module 604, add a third input port through which the second multicast join message is received in an output port list of the third multicast forwarding table item, transmit a PIM join message with no switcher identifier to an upstream PIM router, if the multicast forwarding table item has a switcher identifier, remove the switcher identifier;
if there is no multicast forwarding table item corresponding to the third multicast group in the item storage module 604, generate the third multicast forwarding table item corresponding to the third multicast group, add a third input port through which the second multicast join message is received in an output port list of the third multicast forwarding table item, and transmit a PIM join message with no switcher identifier to an upstream PIM router.

The third item maintaining module 603 is further to:
if there is the third multicast forwarding table item, before adding the third input port in the output port list of the third multicast forwarding table item, determine whether the third input port exists in the output port list of the third multicast forwarding table item;
if the third input port already exists in the output port list of the third multicast forwarding table item, determine whether the third input port in the output port list has a switcher identifier, if the third input port in the output port list has a switcher identifier, remove the switcher identifier, if the third multicast forwarding table item has a switcher identifier, remove the switcher identifier on the third multicast forwarding table item;
otherwise, if the third input port does not exist in the output port list of the third multicast forwarding table item, add the third input port in the output port list of the third multicast forwarding table item.

The item storage module 604 is to store multicast forwarding table items.

According to another example of the present disclosure, the PIM router may be implemented by a processor and a memory, wherein the memory is communicatively connected with the processor and stores machine-readable instructions executable by the processor to perform the operations discussed with reference to FIG. 2 to FIG. 6, including all operations performed by the item maintaining module 501 in FIG. 5, or all operations performed by the first item maintaining module 601, the second item maintaining module 602 and the third item maintaining module 603 in FIG. 6.

The above examples may be implemented by hardware, software, firmware, or a combination thereof. For example the various methods, processes and functional modules described herein may be implemented by a processor (the term processor is to be interpreted broadly to include a CPU, processing module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. Further, the examples disclosed herein may be implemented in the form of a software product. The computer software product is stored in a non-transitory storage medium and comprises a plurality of instructions for making a computer device (which may be a personal computer, a server or a network device, such as a router, switch, access point, etc.) implement the method recited in the examples of the present disclosure.

The figures are only illustrations of an example, in which the modules or procedures shown in the figures are not necessarily essential for implementing the present disclosure. The modules in the aforesaid examples may be combined into one module or further divided into a plurality of sub-modules.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A Protocol Independent Multicast (PIM) router, comprising: an item storage module and a first item maintaining module; wherein
the item storage module is to store multicast forwarding table items;
the first item maintaining module is to:
receive a multicast leave message for leaving a first multicast group through a first input port,
search the item storage module for a first multicast forwarding table item corresponding to the first multicast group,
delete the first input port through which the multicast leave message is received from a first output port list of the first multicast forwarding table item,
if the first input port in the output port list has a switcher identifier and the output port list of the first multicast forwarding table time is empty, delete the first multicast forwarding table item immediately or accelerate a deletion of the first multicast forwarding table item, wherein the switcher identifier indicates that the first input port corresponds to a switcher.

2. The PIM router of claim 1, further comprising: a second item maintaining module, to:
receive a first multicast join message for joining a second multicast group through a second input port, wherein the first multicast join message carries a switcher identifier,
determine whether there is a second multicast forwarding table item corresponding to the second multicast group in the item storage module,
if there is the second multicast forwarding table item corresponding to the second multicast group in the item storage module, add the second input port through which the first multicast join message is received to a second output port list of the second multicast forwarding table item, and add a switcher identifier on the second input port in the second output port list; and
if there is no second multicast forwarding table item corresponding to the second multicast group in the item storage module, generate the second multicast forwarding table item corresponding to the second multicast group in the item storage module, add the second input port through which the first multicast join message is received to the second output port list of the second multicast forwarding table item, and add a switcher identifier on the second input port in the second output port list.

3. The PIM router of claim 2, wherein the second item maintaining module is further to:
if there is no second multicast forwarding table item corresponding to the second multicast group, add a switcher identifier on the newly generated second multicast forwarding table item, and transmit a PIM join message with a switcher identifier to an upstream PIM router.

4. The PIM router of claim 2, wherein the second item maintaining module is further to:
if there is the second multicast forwarding table item corresponding to the second multicast group, before adding the second input port to the second output port list of the second multicast forwarding table item and adding the switcher identifier on the second input port in the second output port list, determine whether the second input port exists in the second multicast forwarding table item,
if the second input port exists in the second multicast forwarding table item, determine whether the second multicast forwarding table item has a switcher identifier, if the second multicast forwarding table item has a switcher identifier, transmit a PIM join message with a switcher identifier to an upstream PIM router; if the second multicast forwarding table item has no switcher identifier, transmit a PIM join message with no switcher identifier to an upstream PIM router;
otherwise, if the second input port does not exist in the second multicast forwarding table item, add the second input port to the second output port list of the second multicast forwarding table item and adding the switcher identifier on the second input port in the second output port list, and
when adding the second input port to the second output port list of the second multicast forwarding table item and adding the switcher identifier on the second input port in the second output port list, determine whether the second multicast forwarding table item has a switcher identifier,
if the second multicast forwarding table item has a switcher identifier, transmit a PIM join message with a switcher identifier to an upstream PIM router; otherwise, transmit a PIM join message with no switcher identifier to an upstream PIM router.

5. The PIM router of claim 1, further comprising: a third item maintaining module, to:
receive a second multicast join message for joining a third multicast group through a third input port, wherein the second multicast join message does not have a switcher identifier;
determine whether there is a third multicast forwarding table item corresponding to the third multicast group in the item storage module;
if there is the third multicast forwarding table item corresponding to the third multicast group in the item storage module, add the third input port to a third output port list of the third multicast forwarding table item, transmit a PIM join message with no switcher identifier to an upstream PIM router, if the third multicast forwarding table item has a switcher identifier, remove the switcher identifier;
if there is no third multicast forwarding table item corresponding to the third multicast group in the item storage module, generate the third multicast forwarding table item corresponding to the third multicast group, add the third input port to the third output port list of the third multicast forwarding table item, and transmit a PIM join message with no switcher identifier to an upstream PIM router.

6. The PIM router of claim 5, wherein the third item maintaining module is further to:
if there is the third multicast forwarding table item, before adding the third input port to the third output port list of the third multicast forwarding table item, determine whether the third input port exists in the third output port list of the third multicast forwarding table item;
if the third input port already exists in the third output port list of the third multicast forwarding table item, determine whether the third input port in the third output port list has a switcher identifier, if the third input port in the third output port list has a switcher identifier, remove the switcher identifier, if the third multicast forwarding table item has a switcher identifier, remove the switcher identifier on the third multicast forwarding table item;
otherwise, if the third input port does not exist in the third output port list of the third multicast forwarding table item, add the third input port in the third output port list of the third multicast forwarding table item.

7. The PIM router of claim 1, wherein the first item maintaining module is further to:
after deleting the first input port from the first output port list of the first multicast forwarding table item, if the first input port in the first output port list does not have a switcher identifier and the first output port list is not empty, determine whether one or more remaining output ports in the first output port list have switcher identifiers, and if yes, add a switcher identifier on the first multicast forwarding table item.

8. A method for maintaining a multicast forwarding table item, comprising:
receiving, by a Protocol Independent Multicast (PIM) router, a multicast leave message for leaving a first multicast group through a first input port,
finding, by the PIM router, a first multicast forwarding table item corresponding to the first multicast group in the PIM router,
deleting the first input port through which the multicast leave message is received from a first output port list of the first multicast forwarding table item,
if there is a switcher identifier on the first input port in the first output port list and the first output port list of the first multicast forwarding table item is empty, deleting the first multicast forwarding table item immediately or accelerating a deletion of the first multicast forwarding table item, wherein the switcher identifier indicates that the first input port corresponds to a switcher.

9. The method of claim 8, further comprising:
receiving, by the PIM router, a first multicast join message for joining a second multicast group through a second input port, wherein the first multicast join message carries a switcher identifier;
determining, by the PIM router, whether there is a second multicast forwarding table item corresponding to the second multicast group at the PIM router;
if there is a second multicast forwarding table item corresponding to the second multicast group at the PIM router, adding the second input port to a second output port list of the second multicast forwarding table item, and adding a switcher identifier on the second input port in the second output port list; and
otherwise, if there is no second multicast forwarding table item corresponding to the second multicast group in the PIM router, generating the second multicast forwarding table item corresponding to the second multicast group, adding the second input port to the second output port list of the second multicast forwarding table item, and adding a switcher identifier on the second input port in the second output port list.

10. The method of claim 9, further comprising:
if there is no second multicast forwarding table item corresponding to the second multicast group in the PIM router, adding a switcher identifier on the newly generated second multicast forwarding table item, and transmitting a PIM join message with a switcher identifier to an upstream PIM router.

11. The method of claim 9, further comprising:
if there is the second multicast forwarding table item corresponding to the second multicast group in the PIM router, before adding the second input port in the second output port list of the second multicast forwarding table item and adding the switcher identifier on the second input port, determining whether the second input port exists in the second multicast forwarding table item;
if the second input port exists in the second multicast forwarding table item, determining whether the second multicast forwarding table item has a switcher identifier, if the second multicast forwarding table item has a switcher identifier, transmitting a PIM join message with a switcher identifier to an upstream PIM router; otherwise, transmitting a PIM join message with no switcher identifier to an upstream PIM router;
otherwise, if the second input port does not exist in the second multicast forwarding table item, adding the second input port in the second output port list of the second multicast forwarding table item and adding the switcher identifier on the second input port; and
when adding the second input port in the second output port list of the second multicast forwarding table item and adding the switcher identifier on the second input port in the second output port list, determining whether the second multicast forwarding table item has a switcher identifier, if the second multicast forwarding table item has a switcher identifier, transmitting a PIM join message with a switcher identifier to the upstream PIM router; otherwise, transmitting a PIM join message without a switcher identifier to the upstream PIM router.

12. The method of claim 8, further comprising:
when receiving a second multicast join message for joining in a third multicast group through a third input port, wherein the second multicast join message has no switcher identifier, determining, by the PIM router, whether there is a third multicast forwarding table item corresponding to the third multicast group in the PIM router;
if there is a third multicast forwarding table item corresponding to the third multicast group in the PIM router, adding the third input port to a third output port list of the third multicast forwarding table item, transmitting a PIM join message with no switcher identifier to an upstream PIM router; if the third multicast forwarding table item has a switcher identifier, removing the switcher identifier;
if there is no third multicast forwarding table item corresponding to the third multicast group in the PIM router, generating the third multicast forwarding table item, adding the third input port to the third output port list of the third multicast forwarding table item, and transmitting a PIM join message with no switcher identifier to an upstream PIM router.

13. The method of claim 12, further comprising:
if there is the third multicast forwarding table item, before adding the third input port in the third output port list of the third multicast forwarding table item, determining whether the third input port exists in the third output port list of the third multicast forwarding table item;
if the third input port exists in the third output port list of the third multicast forwarding table item, determining whether the third input port in the third output port list has a switcher identifier, if the third input port in the third output port list has a switcher identifier, removing the switcher identifier; determining whether the third multicast forwarding table item has a switcher identifier, if the third multicast forwarding table item has a switcher identifier, removing the switcher identifier on the third multicast forwarding table item.

14. The method of claim 8, further comprising:
after deleting the first input port from the first output port list of the first multicast forwarding table item, if the first input port in the first output port list has a switcher identifier and the first output port list is not empty, determining whether one or more remaining output ports in the output port list have switcher identifiers, and if yes, adding a switcher identifier on the first multicast forwarding table item.

15. The method of claim 8, wherein the multicast join or leave message is an Internet Group Management Protocol (IGMP) message, or a Multicast Listener Discovery (MLD) message.
